(19) United States
(12) Patent Application Publication
(10) Pub. No.: US 2011/0175593 A1
(43) Pub. Date: Jul. 21, 2011

(54) BANDGAP VOLTAGE REFERENCE CIRCUIT AND INTEGRATED CIRCUIT INCORPORATING THE SAME

(75) Inventor: Naoki OOKUMA, Kanagawa (JP)

(73) Assignee: RENESAS ELECTRONICS CORPORATION, Kanagawa (JP)

(21) Appl. No.: 13/011,322

(22) Filed: Jan. 21, 2011

(30) Foreign Application Priority Data
Jan. 21, 2010 (JP) 2010-011113

(51) Int. Cl. G05F 3/16

(52) U.S. Cl. 323/313

(57) ABSTRACT

A bandgap voltage reference circuit is provided with: a feedback circuitry, first and second PN junction elements and first and second resistor elements. The feedback circuitry provides a feedback so as to reduce a voltage between first and second nodes. The first PN junction element is connected between the first node and a ground terminal so as to allow a first current from the first node to the ground terminal to flow in a forward direction of a PN junction. The second PN junction element is connected between the first node and a ground terminal so as to allow a first current from the first node to the ground terminal to flow in a forward direction of a PN junction. The first resistor element is connected between the first node and the first PN junction element, and a second resistor element is connected between the second node and the second PN junction element.

### INCORPORATION BY REFERENCE

This application claims the benefit of priority based on Japanese Patent Application No. 2010-011113, filed on Jan. 21, 2010, the disclosure of which is incorporated herein by reference.

### BACKGROUND OF THE INVENTION

1. Field of the Invention

The present invention is related to a voltage reference circuit, more particularly, to a bandgap voltage reference circuit which is configured to generate a reference voltage stabilized against the temperature, making use of characteristics of a current flowing through a PN junction.

2. Description of the Related Art

Due to the increase in the scale of the LSI (large scale integrated circuit), mixed analog-digital LSIs have been recently showing an increasing demand. Conventionally, a power supply for an analog circuit requiring high accuracy, such as a PLL circuits and a bandgap voltage reference circuit, is usually separated from a power supply for a logic circuit in order to avoid power supply noise. In the viewpoint of chip cost reduction, however, it is preferable that the power supply is shared by an analog circuit and a logic circuit. As a result, there has been an increasing demand for an analog circuit which is tolerant against power supply noise.

FIG. 1 is a circuit diagram showing an exemplary schematic configuration of a commonly-used bandgap voltage reference circuit. The bandgap voltage reference circuit of FIG. 1 is provided with an operational amplifier AMP, bipolar transistors Q₁ and Q_{2,} and resistor elements R₁, R₂ and R₂₀. The bipolar transistors Q₁ and Q₂ each have a commonly-connected collector and base, operating as a diode. The emitter of the bipolar transistor Q₁ is directly connected to a node N₁ and the emitter of the bipolar transistor Q₂ is connected to a node N₂ through the resistor R20. The resistor element R₁ is connected between the node N₁ and the output of the operational amplifier AMP and the resistor element R₂. The nodes N₁ and N₂ are connected to the non-inverting and inverting inputs of the operational amplifier AMP, respectively, and thereby the output voltage of the operational amplifier AMP is controlled to reduce the voltage between the nodes N₁ and N₂ to zero. The output voltage of the operational amplifier AMP is used as a resultant reference voltage V_{REF} and therefore the bandgap voltage reference circuit of FIG. 1 is configured to stabilize the reference voltage V_{REF} to against the temperature.

The circuit configuration of FIG. 1, however, undesirably suffers from deterioration in the accuracy of the reference voltage V_{REF} due to the power supply noise. The cause of such deterioration is described in the following.

In a case that the currents through the resistor elements R₁ and R₂ are identical due to the same resistance of the resistor elements R₁ and R₂ and the ratio of the area of the emitter of the bipolar transistor Q₂ to that of the bipolar transistor Q₁ is 1:α, the reference voltage V_{REF} is expressed by the following expression:

$${V}_{REF} = {V}_{EB} + \frac{{R}_{2}}{{R}_{20}} ( \frac{kT}{q} ln α + {V}_{OS} ) , \qquad ( 1 )$$

where V_{EB} is the emitter-base voltage of the bipolar transistors Q₁ and Q₂ (which are used as diodes); k is the Boltzmann constant; T is the absolute temperature; q is the elementary charge; and V_{OS} is the offset voltage of the operational amplifier AMP.

As is understood from Expression (1), the reference voltage V_{REF} depends on the offset voltage V_{OS} of the operational amplifier AMP, and the offset voltage V_{OS} causes a significant influence on the accuracy of the reference voltage V_{REF} as discussed below: The temperature dependence of the reference voltage V_{REF} is expressed by the following Expression (2), which is obtained by partial differentiation of Expression (1) with respect to the absolute temperature T:

$$\frac{\partial {V}_{REF}}{\partial T} = \frac{\partial {V}_{EB}}{\partial T} + \frac{{R}_{2}}{{R}_{20}} ( \frac{k}{q} ln α ) , \qquad ( 2 )$$

where ∂V_{OS}/∂T is approximated as zero (this approximation is reasonable in actual use). Referring to Expression (2), ∂v_{OS}/∂T is about −2.0 (mV/k), and k/q is about 0.086 (mV/k), when silicon transistors are used as the bipolar transistors Q₁ and Q₂, that is, PN junctions of silicon are used. For α=8, for example, the ratio R₂/R₂₀ required to adjust ∂v_{OS}/∂T in Expression (2) to zero is 11.19. In this case, the reference voltage V_{REF} experiences a change of ten or more times of a change in the offset voltage V_{OS}, as is understood from Expression (1). Accordingly, the reduction of the offset voltage V_{OS} of the operational amplifier AMP is important for improvement in the accuracy of the bandgap voltage reference circuit.

In the circuit configuration shown in FIG. 1, however, the power supply noise undesirably increases the effective offset voltage V_{OS} of the operational amplifier AMP, deteriorating the accuracy of the bandgap voltage reference circuit. In the bandgap voltage reference circuit shown in FIG. 1, the output voltage of the operational amplifier AMP (that is, the reference voltage V_{REF}) is influenced by the power supply noise, because the output voltage is generated on the power supply voltage VDD. When the noises transmitted to the differential inputs of the operational amplifier AMP are different in the noise level between Paths 1 and 2 shown in FIG. 1, the difference between the voltages V₁ and V₂ on the non-inverting and inverting inputs is increased and this results in that the effective offset voltage V_{OS} is increased, causing the deterioration of the accuracy of the reference voltage V_{REF}.

In detail, a small signal equivalent resistance R_{Di} of a PN junction in a low frequency region (or the small signal resistance of the emitter-base junctions of the bipolar transistors Q1 and Q₂) is expressed by the following expression:

$${R}_{Di} = {( \frac{\partial {I}_{Di}}{\partial {V}_{EB}} )}^{- 1} = \frac{kT}{q} \cdot \frac{1}{{I}_{Di}} , \qquad ( 3 )$$

where I_{Di} is the current flowing through the PN junction. The ac signal component v₁ transmitted to the non-inverting input of the operational amplifier AMP through Path 1 and the ac signal component v₂ transmitted to the inverting input of the operational amplifier AMP through Path 2 are given with the ac signal component v_{REF} of the reference voltage V_{REF} as the following expressions, respectively:

$$\begin{matrix}{v}_{1} = \frac{{R}_{Di}}{{R}_{Di} + {R}_{1}} \cdot {v}_{REF} , & ( 4 ) \\ {v}_{2} = \frac{{R}_{Di} + {R}_{20}}{{R}_{Di} + {R}_{20} + {R}_{2}} \cdot {v}_{REF} . & ( 5 )\end{matrix}$$

The ratio of the ac signal components fed to the differential inputs of the operational amplifier AMP through Paths 1 and 2 are obtained by the divisions of right sides and left sides of Expressions (4) and (5), respectively, as follows:

$$\frac{{v}_{2}}{{v}_{1}} = 1 + \frac{{R}_{20} \cdot {R}_{1}}{{R}_{Di} ( {R}_{Di} + {R}_{20} + {R}_{2} )} . \qquad ( 6 )$$

The difference between the ac signal components given as Expression (6) appears on the differential inputs of the operational amplifier AMP through the mechanism described above. The ac signal components are virtually superposed onto the offset voltage V_{OS} as the dc offset component of the operation amplifier AMP, because of the response characteristics of the operational amplifier AMP and the parasitic capacitances therein.

Japanese Patent Application Publication No. P2007-305010 A discloses a circuit configuration which cuts off the power supply noise superposed onto the power supply voltage VDD to thereby improve the accuracy of the reference voltage V_{REF}, avoiding the deterioration caused by such mechanism. In the circuit configuration disclosed in this publication, a constant current is fed to a bandgap voltage reference circuit by a constant current supply configured as a current mirror, to thereby reduce the influence of the noise superposed onto the power supply voltage VDD.

The conventional circuit disclosed in this publication, however, undesirably suffers from an increase in the current consumption, since the conventional circuit is added with an additional current path which does not pass through the bandgap voltage reference circuit. In addition, the conventional circuit suffers from a drawback that the actual operation voltage limit is increased above the intrinsic operation voltage limit of the bandgap voltage reference circuit, due to the voltage drop between the source and drain of a PMOS transistor of the current mirror of the constant current supply.

The suppression of the influence of the noise may be achieved by a low pass filter including a resistor element and a capacitor element; however, the use of a capacitor element undesirably causes an increase in the circuit size and the use of a resistor element undesirably increases the operation voltage limit due to the voltage drop.

The person skilled in the art would therefore appreciate that one desirable measure is a circuit design in which the bandgap voltage reference circuit itself is configured to be tolerant against the power supply noise.

### SUMMARY

In an aspect of the present invention, a bandgap voltage reference circuit is provided with: a feedback circuitry providing a feedback so as to reduce a voltage between first and second nodes; a first PN junction element connected between said first node and a ground terminal so as to allow a first current from said first node to the ground terminal to flow in a forward direction of a PN junction; a second PN junction element connected between said first node and a ground terminal so as to allow a first current from said first node to the ground terminal to flow in a forward direction of a PN junction; a first resistor element connected between said first node and said first PN junction element; and a second resistor element connected between said second node and said second PN junction element.

The bandgap voltage reference circuit according to the present invention can generate a reference voltage stabilized against power supply noise.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a circuit diagram showing an exemplary configuration of a commonly-used bandgap voltage reference circuit;

FIG. 2 is a circuit diagram showing an exemplary configuration of a bandgap voltage reference circuit in one embodiment of the present invention;

FIG. 3 is a circuit diagram showing an exemplary configuration of a bandgap voltage reference circuit in another embodiment of the present invention;

FIG. 4 is a circuit diagram showing an exemplary configuration of a bandgap voltage reference circuit in still another embodiment of the present invention; and

FIG. 5 is a block diagram showing an exemplary configuration of an integrated circuit incorporating a bandgap voltage reference circuit of any of the embodiments of the present invention.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

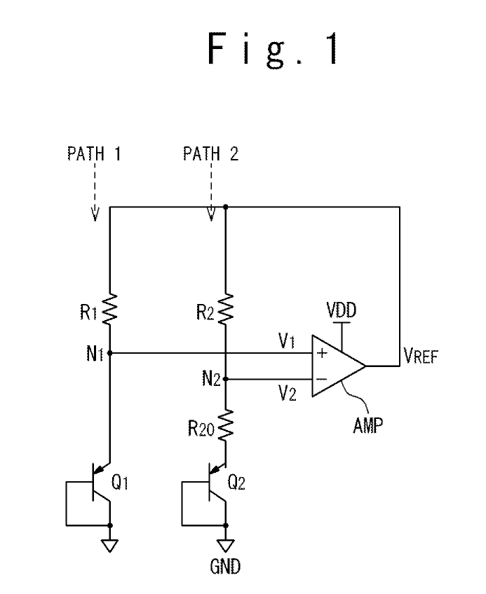

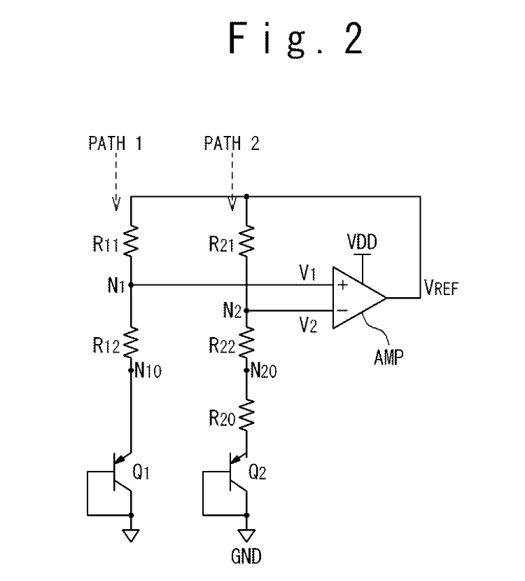

FIG. 2 is a circuit diagram showing an exemplary configuration of a bandgap voltage reference circuit in one embodiment of the present invention. The bandgap voltage reference circuit shown in FIG. 2 is provided with an operational amplifier AMP, bipolar transistors Q₁, Q₂ and resistor elements R₁₁, R₂₁, R₁₂, R₂₂ and R₂₀. As is the case of the bandgap voltage reference circuit shown in FIG. 1, the bipolar transistors Q₁ and Q₂ each have a commonly connected collector and base, operating as a diode. The resistor element R₁ is connected between a node N₁ and the output of the operational amplifier AMP and the resistor element R₂ is connected between a node N₂ and the output of the operational amplifier AMP. The nodes N₁ and N₂ are connected to non-inverting and inverting inputs of the operational amplifier AMP, respectively, and the output voltage of the operational amplifier AMP, that is, the voltage reference V_{REF} is controlled so as to reduce the voltage between the nodes N₁ and N₂ to zero. In the bandgap voltage reference circuit of FIG. 2, the resistor element R₁₂ is inserted between the emitter of the bipolar transistor Q₁ and the node N₁, and the resistor elements R₂₂ and R₂₀ are inserted between the emitter of the bipolar transistor Q₂ and the node N₂. It should be noted here that the resistor elements R₁₂ and R₂₂ have the same resistance. The bandgap voltage reference circuit configuration of this embodiment generates the same reference voltage V_{REF} as the bandgap voltage reference circuit shown in FIG. 1, when the sum of the resistance values of the resistor elements provided between the output of the operational amplifier AMP in Path 1 is identical to the resistance value of the resistor element R₁ of the bandgap voltage reference circuit of FIG. 1 and the sum of the resistance values of the resistor elements provided between the output of the operational amplifier AMP in Path 2 is identical to the resistance value of the resistor element R₂. That is, the same reference voltage V_{REF} is generated in the circuit configurations shown in FIGS. 1 and 2, when R₁=R₁₁+R₁₂ and R₂=R₂₁+R₂₂. In other words, the bandgap voltage reference circuit shown in FIG. 2 is configured so that the non-inverting and inverting inputs of the operational amplifier AMP are disconnected from the nodes N₁₀ and N₂₀, respectively, and connected to the nodes N1 and N2, respectively.

As discussed with reference to Expression (6), the influence of the power supply noise on the offset voltage V_{OS} is suppressed when the ratio of the ac signal components of the voltages inputted to the non-inverting and inverting inputs of the operational amplifier AMP is close to one. In the circuit configuration of FIG. 2, the ratio of the ac signal components is expressed by the following Expression (7):

$${( \frac{{v}_{2}}{{v}_{1}} )}^{′} = 1 + \frac{{R}_{20} \cdot {R}_{11}}{( {R}_{Di} + {R}_{12} ) ( {R}_{Di} + {R}_{20} + {R}_{21} + {R}_{22} )} , \qquad ( 7 )$$

where R₁₂=R₂₂.

In the following, Expressions (6) and (7) are rewritten so that the resistor elements of the same resistance value are denoted by the same notation. Expressions (6) and (7) can be rewritten with R_{Di}, R₂, R₂₀ and R₂₂ as follows:

$$\begin{matrix}( \frac{{v}_{2}}{{v}_{1}} ) = 1 + \frac{{R}_{20}}{{R}_{Di} + {R}_{20} + {R}_{2}} \cdot \frac{{R}_{2}}{{R}_{Di}} , & {( 6 )}^{′} \\ {( \frac{{v}_{2}}{{v}_{1}} )}^{′} = 1 + \frac{{R}_{20}}{{R}_{Di} + {R}_{20} + {R}_{2}} \cdot \frac{{R}_{2} - {R}_{22}}{{R}_{Di} + {R}_{22}} , & {( 7 )}^{′}\end{matrix}$$

since it holds:

R₁=R₁₁+R₁₂,

R₂=R₂₁+R₂₂,

R₁=R₂,

R₁₁=R₂₁, and

R₁₂=R₂₂,

as described above. The second term of Expression (7)′ is smaller than that of Expression (6)′, since it holds:

R_{Di}<RDi+R22, and (8)

R₂>R₂−R₂₂, (9)

as is understood from comparisons of the numerators and denominators of the second terms of Expressions (6)′ and (7). Therefore, it holds:

$$( \frac{{v}_{2}}{{v}_{1}} ) > {( \frac{{v}_{2}}{{v}_{1}} )}^{′} ( > 1 ) . \qquad ( 10 )$$

As thus discussed, the circuit configuration of FIG. 2 effectively suppresses the influence of the power supply noise on the offset voltage V_{OS}, reducing the ac signal components of the voltages inputted to the non-inverting and inverting inputs of the operational amplifier AMP.

An increased resistance of the resistor element R₂₂ effectively enhances the effect of the suppression of the influence of the power supply noise. According to the second term of Expression (7)′, an increase in R₂₂ results in a decrease in the numerator and an increase in the denominator, making (v2/v1)′ closer to one. It should be noted here that R₂₂<R₂, because R₂=R₂₁+R₂₂.

Although an increased resistance of the resistor element R₂₂ effectively enhances the effect of the suppression of the influence of the power supply noise as thus discussed, the increase in R₂₂ also increases the offset voltage V_{OS} caused by the feedback operation of the operational amplifier AMP. The increased offset voltage V_{OS}′ is given by Expression (11) which is expressed only with R₂, R₂₀ and R₂₂ as is the case of Expression (7)′:

$${V}_{OS}^{′} = ( 1 + \frac{{R}_{22}}{{R}_{21}} ) \cdot {V}_{OS} = ( 1 + \frac{{R}_{22}}{{R}_{2} - {R}_{22}} ) \cdot {V}_{OS} . \qquad ( 11 )$$

Expression (11) implies that, when the effect of the suppression of the accuracy deterioration caused by the power supply noise is enhanced, this undesirably causes an increase in offset voltage of the operational amplifier AMP.

As thus discussed, the increase in R₂₂ effectively reduces the difference of the ac signal components caused by the power supply noise, while undesirably making the influence of the offset voltage of the operational amplifier worse. This implies that an appropriate value of the resistance of the resistor element R₂₂ should be determined on the basis of the comparison between the effects of the power supply noise and the amplifier offset.

Although the resistor elements R₂₂ and R₂₀ are shown as separate elements in FIG. 2 for understanding of the circuit operation, the resistor elements R₂₂ and R₂₀ may be integrated as a single resistor element in an actual integration. When the single resistor element is denoted by symbol Rₓ, the circuit topology shown in FIG. 2 can be understood as a circuit topology in which the resistor element R₁₂ is inserted between the emitter of the bipolar transistor Q₁ and the node N₁, and the resistor element Rₓ is inserted between the emitter of the bipolar transistor Q₂ and the node N₂.

The circuit configuration in which resistor elements are inserted between the node N₁ and the emitter of the bipolar transistor Q₁ and between the node N₂ and the emitter of the bipolar transistor Q₂ to reduce the variations of the reference voltage V_{REF} due to the power supply noise as shown in FIG. 2 is applicable to any bandgap voltage reference circuit which is configured to reduce the voltage between the nodes N₁ and N₂ to zero through feedback control.

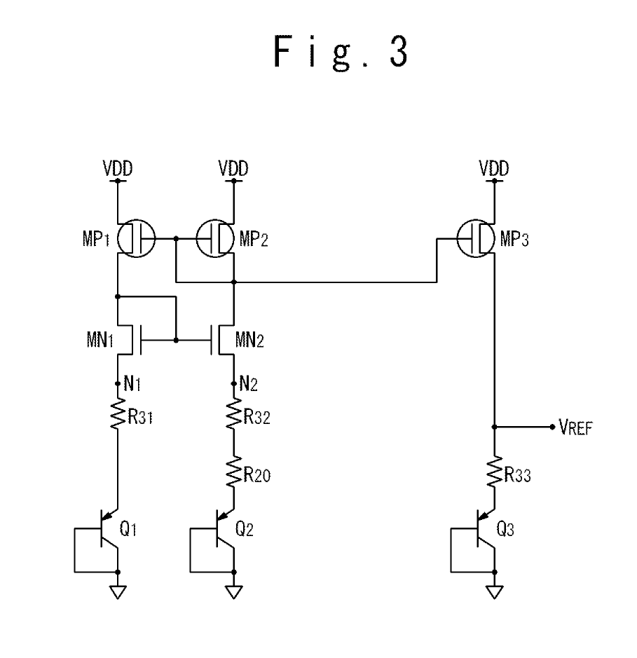

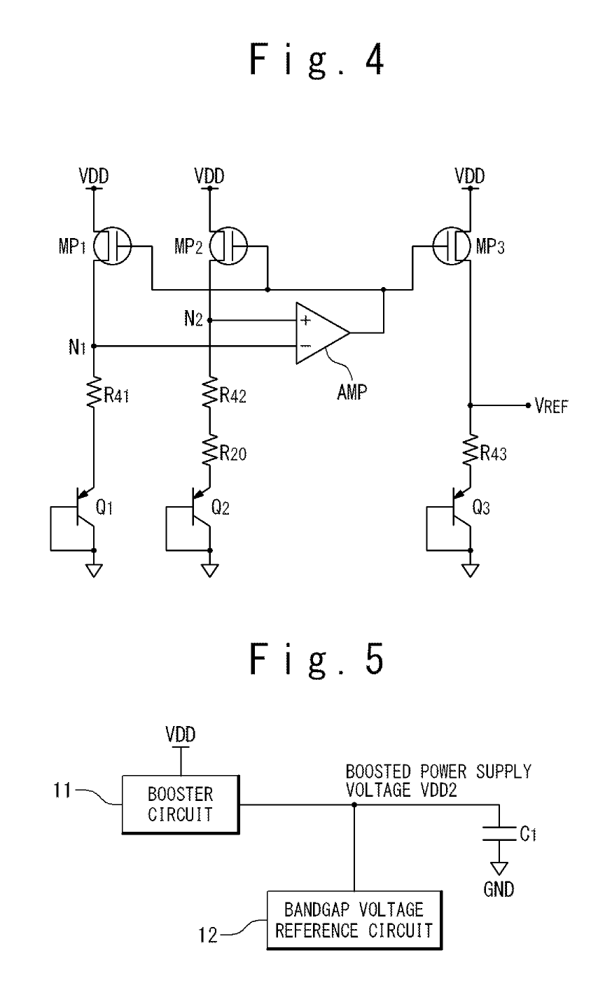

FIGS. 3 and 4 are circuit diagram showing exemplary configurations of bandgap voltage reference circuits in alternative embodiments of the present invention. The bandgap voltage reference circuit of FIG. 3 is provided with PMOS transistors MP₁ to MP₃, NMOS transistors MN₁ and MN₂, resistor elements R₃₁ to R₃₃, R₂₀ and bipolar transistors Q₁ to Q₃. It should be noted here that the resistor element R₃₁ provided between the emitter of the bipolar transistor Q₁ and the node N₁ has the same resistance as the resistor element R₃₂ provided between the emitter of the bipolar transistor Q₂ and the node N₂.

The PMOS transistors MP₁ and MP₂ form a first current mirror connected to a power supply terminal fed with the power supply voltage VDD. More specifically, PMOS transistors MP₁ and MP₂ have sources commonly connected to the power supply terminal fed with the power supply voltage VDD and gates commonly connected to the drain of the PMOS transistor MP₂.

The NMOS transistors MN₁ and MN₂ form a second current mirror connected to the first current mirror. More specifically, the NMOS transistors MN₁ and MN₂ have drains connected to the drains of the PMOS transistors MP₁ and MP₂, respectively, and gates commonly connected to the drain of the NMOS transistor MN₁. The sources of the NMOS transistors MN₁ and MN₂ are connected to the node N₁ and N₂, respectively.

In the circuit configuration shown in FIG. 3, the first and second current mirrors provide feedback control so as to reduce the voltage between the node N₁ and N₂ to zero.

The PMOS transistor MP₃, the bipolar transistor Q₃ and the resistor element R₃₃ function as an output stage which outputs the reference voltage V_{REF} in response to the voltage level on the commonly-connected gates of the PMOS transistors MP₁ and MP₂. In detail, the PMOS transistor MP₃ has a gate connected to the gate of the PMOS transistor MP₂ and a source connected to the power supply terminal. The bipolar transistor Q₃ has a commonly connected collector and base, operating as a diode. The resistor element R₃₃ is connected between the drain of the PMOS transistor MP₃ and the emitter of the bipolar transistor Q₃. The reference voltage V_{REF} is outputted from the drain of the PMOS transistor MP₃.

The circuit configuration shown in FIG. 3 also reduces ac signal components transmitted to the node N₁ and N₂ resulting from the power supply noise to thereby suppress the deterioration of the accuracy of the reference voltage V_{REF}, since resistor elements are inserted between the node N₁ and the emitter of the bipolar transistor Q₁ and between the node N₂ and the emitter of the bipolar transistor Q₂.

An increased resistance of the resistor elements R₃₁ and R₃₂ (which have the same resistance) effectively suppresses the influence of the power supply noise, also in the circuit configuration FIG. 3. It should be noted that the increase in the resistance of the resistor elements R₃₁ and R₃₂ does not cause an increase in the influence of the offset voltage as in the circuit configuration shown in FIG. 2; however, the increase in the resistance of the resistor elements R₃₁ and R₃₂ undesirably increases the voltage levels on the nodes N₁ and N₂, resulting in deterioration of the operation margin of the power supply voltage VDD. The increase in the resistance of the resistor elements R₃₁ and R₃₂ also causes an undesired increase in the area thereof. This implies that an appropriate resistance of the resistor elements R₃₁ and R₃₂ should be determined on the basis of the comparison between the effect of the power supply noise, the operation margin of the power supply voltage VDD and the area of the resistor elements R₃₁ and R₃₂.

In the circuit configuration shown in FIG. 3, the resistor elements R₃₂ and R₂₀ may be integrated as a single resistor element in an actual integration.

On the other hand, the bandgap reference circuit shown in FIG. 4 is provided with PMOS transistors MP₁ to MP₃, resistor elements R₄₁ to R₄₃, R₂₀, an operational amplifier AMP, and bipolar transistors Q₁ to Q_{3.} The resistor element R₄₁, which is connected between the emitter of the bipolar transistor Q₁ and the node N₁, has the same resistance as the resistor element R₄₂, which is connected between the emitter of the bipolar transistor Q₂ and the node N₂. The PMOS transistors MP₁ and MP₂ have sources commonly connected to a power supply terminal, drains connected to the node N₁ and N₂, respectively, and gates commonly connected to the operational amplifier AMP. In the circuit configuration shown in FIG. 4, the operational amplifier AMP and the PMOS transistors MP₁ and MP₂ provide feedback control to reduce the voltage between the node N₁ and N₂ to zero. The PMOS transistor MP₃, the bipolar transistor Q₃ and the resistor element R₄₃ function as an output stage which outputs the reference voltage V_{REF} in response to the output level of the operational amplifier AMP.

The circuit configuration shown in FIG. 4 also reduces ac signal components transmitted to the node N₁ and N₂ resulting from the power supply noise to thereby suppress the deterioration of the accuracy of the reference voltage V_{REF}, since resistor elements are inserted between the node N₁ and the emitter of the bipolar transistor Q₁ and between the node N₂ and the emitter of the bipolar transistor Q₂.

An increased resistance of the resistor elements R₄₁ and R₄₂ (which have the same resistance) effectively suppresses the influence of the power supply noise, also in the circuit configuration FIG. 4. It should be noted that the increase in the resistance of the resistor elements R₄₁ and R₄₂ does not cause an increase in the influence of the offset voltage as in the circuit configuration shown in FIG. 2; however, the increase in the resistance of the resistor elements R₄₁ and R₄₂ undesirably increases the voltage levels on the nodes N₁ and N₂, resulting in deterioration of the operation margin of the power supply voltage VDD. The increase in the resistance of the resistor elements R₄₁ and R₄₂ also causes an undesired increase in the area thereof. This implies that an appropriate resistance of the resistor elements R₄₁ and R₄₂ should be determined on the basis of the comparison between the effect of the power supply noise, the operation margin of the power supply voltage VDD and the area of the resistor elements R₄₁ and R₄₂.

In the circuit configuration shown in FIG. 4, the resistor elements R₄₂ and R₂₀ may be integrated as a single resistor element in an actual integration.

It is especially preferable that a bandgap voltage reference circuit according to the present invention (for example, those shown in FIGS. 2 to 4) is applied to a circuit which receives a boosted power supply voltage generated by a booster circuit. It is difficult to operate a bandgap voltage reference circuit in a low voltage device, such as a device with a single 1.0V power supply. In such device, a boosted power supply voltage (for example, a power supply voltage higher than 1.0V) is generated with a booster circuit and a bandgap voltage reference circuit is operated on the boosted power supply voltage. The use of a bandgap voltage reference circuit according to the present invention is quite advantageous in such case, since the boosted power supply voltage experiences significantly large noise.

FIG. 5 is a block diagram showing an exemplary configuration of an integrated circuit in which a bandgap voltage reference circuit according to the present invention is used in combination with a boosting power supply. The integrated circuit shown in FIG. 5 is provided with a booster circuit 11 and a bandgap voltage reference circuit according to the present invention (denoted by numeral 12). A charge pump may be used as the booster circuit 11, for example. A boosted power supply voltage VDD2 is generated on a boosted power supply line by the booster circuit 11 and fed to the bandgap voltage reference circuit 12. The bandgap voltage reference circuit 12 may be configured in accordance with any of the circuit configurations shown in FIGS. 2 to 4. A power supply capacitor C₁ is provided between the boosted power supply line and a ground line.

Large power supply noise generated by the booster circuit 11 necessitates a measure, for example, an increase in the capacitance of the power supply capacitor C₁. When the power supply noise is suppressed by the technique disclosed in the above-mentioned Japanese Patent Application Publication No. P2007-305010 A, for example, the current consumption is increased and this necessitates an enhancement of the drive capacity of the booster circuit 11, that is, the element areas of the circuit elements thereof to compensate the current consumption. The technique disclosed in this application also causes a higher operation voltage limit, necessitating an increase in the boosted power supply voltage VDD2 and this undesirably increases the element areas of the circuit elements of the booster circuit 11.

The use of any of the bandgap voltage reference circuits of the above-described embodiments, which are configured to be tolerant against the power supply noise, effectively suppresses the increase in the element areas of the circuit elements of the booster circuit 11 and allows reducing the element area of the power supply capacitor C₁, if it is used for the suppression of the power supply noise. As thus discussed, the present invention offers a significant advantage in reduction of the element areas, especially when the present invention is implemented in combination with a boosting power supply.

It is apparent that the present invention is not limited to the above embodiments, but may be modified and changed without departing from the scope of the invention.

What is claimed is:

1. A bandgap voltage reference circuit, comprising:
a feedback circuitry providing a feedback so as to reduce a voltage between first and second nodes;
a first PN junction element connected between said first node and a ground terminal so as to allow a first current from said first node to the ground terminal to flow in a forward direction of a PN junction;
a second PN junction element connected between said first node and a ground terminal so as to allow a first current from said first node to the ground terminal to flow in a forward direction of a PN junction;
a first resistor element connected between said first node and said first PN junction element; and
a second resistor element connected between said second node and said second PN junction element.

2. The voltage reference circuit according to claim 1, wherein said feedback circuitry includes:
an operational amplifier having a first input connected to said first node and a second input connected to said second node;
a third resistor element connected between an output of said operational amplifier and said first node; and
a fourth resistor element connected between the output of said operational amplifier and said second node.

3. The voltage reference circuit according to claim 1, further comprising an output stage, wherein said feedback circuitry includes first and second current mirrors,
wherein said first current mirror includes first and second PMOS transistors having sources connected to a power supply terminal and commonly-connected gates,
wherein said second current mirror includes first and second NMOS transistors having sources connected to said first and second nodes, respectively and commonly-connected gates,
wherein drains of said first PMOS transistor and said first NMOS transistor are commonly connected to a third node,
wherein drains of said second PMOS transistor and said second NMOS transistor are commonly connected to a fourth node,
wherein the gates of said first and second PMOS transistors are connected to one of said third and fourth nodes,
wherein the gates of said first and second NMOS transistors are connected to the other of said third and fourth nodes, and
wherein said output stage outputs a reference voltage in response to a voltage level on the gates of said first and second PMOS transistors.

4. The voltage reference circuit according to claim 1, further comprising an output stage, wherein said feedback circuitry includes:
an operational amplifier having a first input connected to said first node and a second input connected to said second node; and
first and second PMOS transistors having sources connected to a power supply terminals and gates commonly connected to an output of said operational amplifier,
wherein drains of said first and second PMOS transistors are connected to said first and second nodes, respectively, and
wherein said output stage outputs a reference voltage in response to a voltage level on the output of said operational amplifier.

5. An integrated circuit, comprising:
a booster circuit boosting a first power supply voltage to generate a second power supply voltage; and
a voltage reference circuit operating on said second power supply voltage,
wherein said voltage reference circuit includes:
a feedback circuitry providing a feedback so as to reduce a voltage between first and second nodes;
a first PN junction element connected between said first node and a ground terminal so as to allow a first current from said first node to the ground terminal to flow in a forward direction of a PN junction;
a second PN junction element connected between said first node and a ground terminal so as to allow a first current from said first node to the ground terminal to flow in a forward direction of a PN junction;
a first resistor element connected between said first node and said first PN junction element; and
a second resistor element connected between said second node and said second PN junction element.

6. The integrated circuit according to claim 5, wherein said feedback circuitry includes:
an operational amplifier having a first input connected to said first node and a second input connected to said second node;
a third resistor element connected between an output of said operational amplifier and said first node; and
a fourth resistor element connected between the output of said operational amplifier and said second node.

7. The integrated circuit according to claim 5, wherein said voltage reference circuit further includes an output stage,
wherein said feedback circuitry includes first and second current mirrors,
wherein said first current mirror includes first and second PMOS transistors having sources connected to a power supply terminal receiving said second power supply voltage and commonly-connected gates,
wherein said second current mirror includes first and second NMOS transistors having sources connected to said first and second nodes, respectively and commonly-connected gates,
wherein drains of said first PMOS transistor and said first NMOS transistor are commonly connected to a third node,
wherein drains of said second PMOS transistor and said second NMOS transistor are commonly connected to a fourth node,
wherein the gates of said first and second PMOS transistors are connected to one of said third and fourth nodes,
wherein the gates of said first and second NMOS transistors are connected to the other of said third and fourth nodes, and
wherein said output stage outputs a reference voltage in response to a voltage level on the gates of said first and second PMOS transistors.

8. The integrated circuit according to claim 5, wherein said voltage reference circuit further includes an output stage,
wherein said feedback circuitry includes:
an operational amplifier having a first input connected to said first node and a second input connected to said second node; and
first and second PMOS transistors having sources connected to a power supply terminals and gates commonly connected to an output of said operational amplifier,
wherein drains of said first and second PMOS transistors are connected to said first and second nodes, respectively, and
wherein said output stage outputs a reference voltage in response to a voltage level on the output of said operational amplifier.
